(19) United States
(12) Patent Application Publication
(10) Pub. No.: US 2008/0170479 A1
(43) Pub. Date: Jul. 17, 2008

(54) OPTICAL INFORMATION STORAGE APPARATUS AND OPTICAL RECORDING MEDIUM

(76) Inventors: TAKESHI SHIMANO, Yokohama (JP); Tatsuro Ide, Kawasaki (JP); Kenichi Shimada, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/829,121

(22) Filed: Jul. 27, 2007

(30) Foreign Application Priority Data
Jan. 17, 2007 (JP) 2007-007600

(51) Int. Cl. G11B 7/00

(52) U.S. Cl. 369/44.11

(57) ABSTRACT

In an information recording apparatus using a hologram, a signal area of the light flux to be recorded is secured to be as wide as possible and the optical power loss is depressed during reproduction process. For this reason, almost the entire surface of the spatial light modulator is allocated as a signal area and the reference beam is collected on a micro mirror placed on its optical axis.

### CLAIM OF PRIORITY

The present application claims priority from Japanese application JP 2007-007600 filed on Jan. 17, 2007, the content of which is hereby incorporated by reference into this application.

### FIELD OF THE INVENTION

The present invention relates to an optical information storage apparatus for storing information two dimensionally at a high speed using the principle of holographic recording, and an optical recording medium which is desirable for use in the optical information storage apparatus.

### BACKGROUND OF THE INVENTION

As optical information storage apparatus, systems using optical discs such as CD, DVD, and Blu-ray Discs which are known as optical recording media are generally known. For example, spots produced from a light source such as a semiconductor laser are collected on a disc and the quantity of light reflected on the disc and returned to the lens is detected in order to reproduce signals of the information pit recorded in the disc. Currently, these optical recording media have been widely used as mass distribution media, video recording media and PC information storage media. However, as magnetic recording media such as magnetic discs have larger capacities as high as a few hundreds GB, similar capacities are required for optical discs as recording media which have been used recently as backup media. For this reason, production of larger capacities of a few hundreds GB are expected compared to 25 GB which is the current capacity of Blu-ray Discs.

As large capacity optical recording media, holographic recording method was proposed in JP-A No. 2004-27268 and WO2004/102542. In the holographic recording method, for much recorded information in the light flux, light modulated two dimensionally in the spatial light modulator along with a reference beam is irradiated on a photosensitive media and the information is stored by recording the interference fringe (hologram) on the photosensitive media. When the reference beam used for recording is irradiated under the same conditions during the reproduction process, the hologram recorded in the recording media acts as a diffraction lattice to generate diffracted light. This includes the recorded signal beam and phase information and is reproduced as absolutely the same beam. Since an ordinary diffraction lattice only forms a concave/convex shape with a depth of only one out of a few fractions of the wavelength of light in a lattice form on the plane surface, the length of action mutually acting in the direction of movement of light is short. For this reason, there is no selectivity for the angle of incident light so that a diffracted light is generated with an incident light in the range of wider angles. In contrast, in the holographic recording, if a photosensitive material is arranged to be sufficiently thicker than the wavelength, the length of action in the movement direction of light becomes longer so that the reflected light due to many lattices mutually reacts with each other. Therefore, a diffracted light can be generated only when a reference beam which is the same as that when recorded (Bragg diffraction). Using this selectively, plural holograms can be drawn to be overlapped, making production of further larger capacities possible. Also when reproducing, since much information recorded two dimensionally can be reproduced simultaneously, this is effective for higher speed storage as well as production of larger capacities.

JP-A No. 2004-272268 discloses a system in which a signal light flux entering diagonally to the optical recording medium is collected through a lens while the reference beam in a parallel light flux is irradiated to cause interference.

WO2004/102542 discloses a system in which the signal light flux is collected through a lens perpendicular to an optical recording medium and the light around the condensed light flux collected through the same lens is used as the reference beam.

### SUMMARY OF THE INVENTION

In the method disclosed in JP-A No. 2004-272268, light is condensed diagonally to the optical recording medium and the reference beam is irradiated in a separate optical system having a different optical axis. In such a biaxial optical system, the actions in the two optical paths are mostly different for localized deformation and vibration generally in the optical system. Due to such differences, differential phases of the beams that interfere with each other become unstable and the formed interference fringes tend to be blurry or show through. In reverse, if optical paths are built rigidly in order to avoid such phenomenon or if the entire apparatus tends to become larger and heavier in order to avoid vibration, it is highly possible that the system assumed as an optical disc apparatus as an extension of current DVDs becomes excessively expensive.

In the method disclosed in WO 2004/102542, in contrast, the reference beam is arranged to share the optical axis with the signal beam so that the optical paths are basically shared and the problem with instability of the optical system that has been concerned in the case of the biaxial optical system can be improved significantly. However, since almost half of the area of the light flux must be filled with the reference beam, the information area becomes approximately one half. When reproduced, the light in the area of signal light flux must be shielded with a modulator prior to the irradiation of the recording medium, optical power loss becomes greater and in order to secure a sufficient reproduction signals S/N ratio, it is necessary to slow down the reproduction speed of the signals.

Due to the aforementioned drawbacks, the subject of concern to be solved in the present application is to secure the signal area in the light flux condensed on the optical recording medium to be as wide as possible in the optical system using the same optical axis for the signal beam and for the reference beam, as well as to depress optical power loss during reproduction.

In order to solve the problems, before the signal modulation is applied to the light flux using a spatial light modulator, light is split using a first beam splitting device in order for the signal beam to irradiate the entire surface of the spatial light modulator as well as for the reference beam to be condensed in a very small portion of area in the spatial light modulator. As a result, the area allocated for the reference beam can be reduced and it is possible to secure a wider area to be used as a signal beam.

Also, the intensity ratio between the reference light flux and the signal light flux to be split using a first beam splitting device is adjusted to be variable. For example, if the ratio between the reference light flux and the signal light flux is set to be 1 to 1 while recording, visibility of the hologram recorded is secured. If the intensity of the signal light flux is set to be zero during reproduction so that all the optical power is allocated to the reference light flux, the optical power loss during reproduction can be depressed.

Also, when using a reflective type modulator such as a digital mirror device (DMD) as a spatial light modulator, if a micro mirror is arranged at the position where the reference light flux is condensed, the reflectivity of the reference beam is increased to prevent photon loss as well as to reduce damage to the modulator which is caused by high optical power density.

Also, if the position where the reference light flux is condensed in the spatial light modulator is arranged on the optical axis, the optical axis is shared so that stability of the optical system against deformation and vibration can be secured.

Also, if a photo detector which selectively detects the reflected light of the reference beam from the disc is installed, a control signal of the condensing position on the disc can be obtained from this beam. An astigmatic method used in the conventional optical disc and a focus error detection method such as a beam size detection method and a knife edge method can be applied in this case and as a result, a focus error signal can be obtained. Moreover, if a guiding groove and a row of pits with high reflectivity are arranged on the optical recording medium, a tracking signal can be obtained from the reflected light. By so doing, the condensing position during recording and the condensing position during reproducing can be controlled at the same time so that a high reproducing signal quality can be obtained.

Also, if the intensity of the recording signal light flux is modulated by recorded information in the spatial light modulator and if random phase modulation is applied, it can prevent the phenomenon when interference intensity is excessively intensified in the center area. As a result, a dynamic range of exposure with a photosensitive medium can be used effectively and the degree of multiple recording can be improved.

Moreover, in the optical information recording medium, a photosensitive material layer such as a photo polymer with a thickness of 1 mm is installed on the surface of the transparent substrate such as glass and plastics, and on the back of the transparent substrate, a row of pits with a low reflectivity with a pit depth of approximately λ/(4n) (λ: optical wavelength, n: substrate refractive index) is installed. As a result, when the reference beam with controlled tracking by the row of pits is positioned between the pits to have a high reflectivity, a hologram is formed. By setting the pit depth at λ/(4n), the reflectivity in the pit can be depressed while a tracking signal can be detected by the differential phase detection method (DPD method) in which the signal amplitude becomes largest at this pit depth.

Therefore, a large capacity and high speed holographic storage system can be implemented in a simple configuration which is similar to that in the conventional optical disc device and the system implemented is desirable as a backup system for a large capacity magnetic disc device.

### BRIEF DESCRIPTION OF THE DRAWINGS

FIG. 1 is a basic embodiment of the present invention;

FIG. 2 is a diagram showing the relative dimensional relationships between pits and spots;

FIG. 3 is a view showing a hologram forming area; and

FIG. 4 is a diagram showing a configuration of the servo signal detection circuit.

### DETAILED DESCRIPTION OF THE PREFERRED EMBODIMENTS

An embodiment of the present invention will be explained with reference to the drawings.

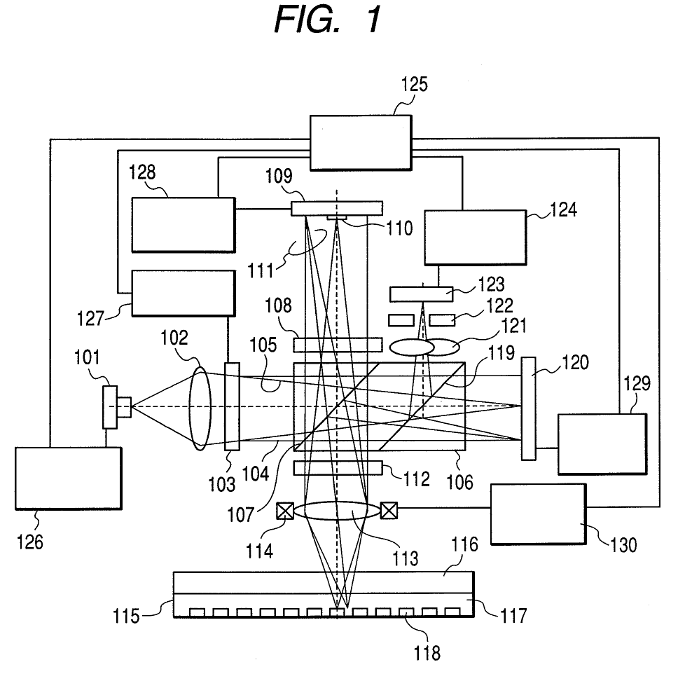

FIG. 1 is a diagram showing the basic embodiment of the present invention.

Light from a semiconductor laser light source 101 is condensed through a coupling lens 102 and passes through a variable beam splitting device 103 forming a reference light flux 105 which reflects on the polarization prism reflective surface 107 of the composite prism 106, then transmits through a λ/4 plate and is converged on a micro mirror equipped in the center of the spatial light modulator 109. Also, the variable beam splitting device 103 converts a part of the light flux entering based on the voltage applied from the liquid crystal driver circuit 126 to a parallel light flux forming as a recording light flux 104 which irradiates the entire surface of the spatial light modulator 109 via the same pathways. The variable beam splitting device 103 has such a structure in which liquid crystal molecules are sandwiched with glass substrates having a transparent electrode pattern in the Fresnel zone plate such that the orientation of the liquid molecules changes based on the voltage applied and a differential phase is generated against the linear polarization along the direction of orientation to generate diffraction lens action. The λ/4 plate 108 converts entering reference light flux 105 and the recording light flux 104 to a circular polarization. The spatial light modulator 109 is comprised of a micro electromechanical system MEMS mirror array called a digital mirror device (DMD) and the micro electromechanical system (MEMS) mirror can be inclined according to the modulation signals applied to each pixel by the spatial light modulator driver 127. If the micro electromechanical system (MEMS) mirror is inclined, the direction of the reflected light is greatly inclined so that the reflected light intensity is substantially modulated to either ON/OFF. Moreover, a random phase shift filter (not shown) is installed on the DMD surface so that the phase distribution of the reflected light is modulated randomly in a fixed manner. As a result, the signal light fluxes mutually interfere with each other so that the formation of spots with an extremely strong power density can be avoided. If a strong power density is locally concentrated, the photosensitive material is completely sensitized in this area, disabling the required multiplex exposure. In order to prevent this from happening, a random phase shift is necessary. The reference light flux reflected from the micron mirror 110 and the signal light flux reflected from one micro variable mirror (a light flux 111 is shown as a representative spot) pass through the λ/4 plate again and are converted to a linear polarization perpendicular to that at the time of incidence, are transmitted through the polarization prism 107 of the composite prism 106, and then converted again to a circular polarization by the second λ/4 plate 112 and converge on the optical recording media 115 via the condensing lens 113.

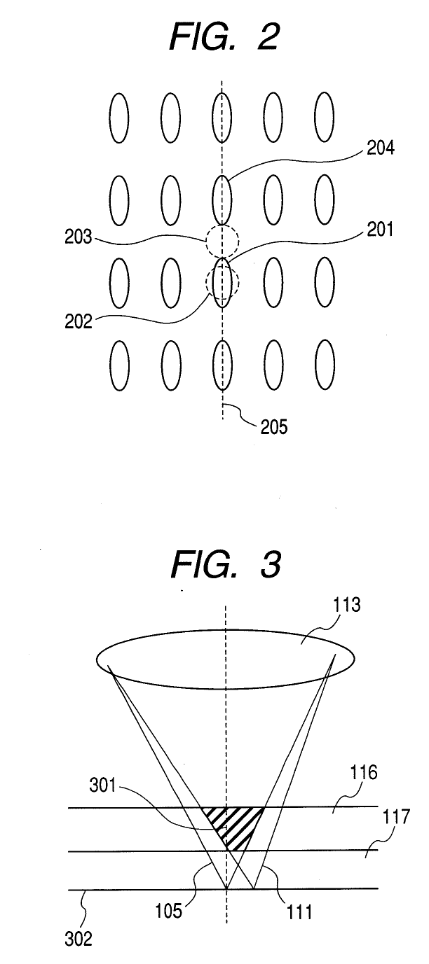

The recording medium 115 is comprised of a photo polymer photosensitive material layer 116 and a transparent substrate 117 having a row of pits 118. The depth of the row of pits 118 is almost ¼ of the optical path length of the wavelength and the tracking signals generated by the differential phase detection: DPD method used in DVDs can be detected. Moreover, these pits also play the role of addresses that determine the positions of the holograms to be recorded. That is, the quantity of light of the reflected light from the spots of the reference light flux condensed on the pit is reduced by interference so that an address can be determined by counting the pulses of the signals of the total quantity of light for the reflected reference light flux. FIG. 2 shows the relative dimensional relationships between pits and spots. When the condensed spot 202 of the reference light flux is tracking on the row of pits 205 according to the DPD method, the reflective index at the position of the spot 202 on the pit 201 decreases, while the reflective index at the positions of spot 203 between the pits 201 and 204 increases. Therefore, one sheet of holograms is arranged to be recorded when the spot is located at the position 203. If a spot is located between the pits, the signal light flux is reflected by the spatial light modulator 109. Alternatively, On/Off control of the signal light flux can be carried out by the variable beam splitting device 103.

FIG. 3 is a diagram showing a hologram forming area due to interference between the reference light flux 105 and the signal light flux 111 reflected from one of the variable micro mirrors on the spatial light modulator 109 as a representative point. A hologram 301 is formed in the area in which the reference light flux 105 and the signal light flux 111 are overlapped in the photo polymer photosensitive material layer 116. Actually the hologram 301 is the overlapped total of four interference fringes not only comprising of a first interference fringe formed between the light in the going path of the reference flux 105 towards the reflective surface 302 and the light in the going path of the signal light flux 111, but also a second interference fringe by the return path light of the reference light flux and the return path light of the signal light flux, a third inference fringe by the going path light of the reference light flux and the return path light of the signal light flux, and a fourth inference fringe by the return path light of the reference light flux and the going path light of the signal light flux. The first and second interference fringes form a transmittance type hologram forming an interference fringe layer approximately perpendicular to the bottom surface of the recording medium 115, whereas the third and fourth interference fringes form a reflective type hologram forming an approximately parallel interference fringe layer. Any of the holograms generates a reproduced signal light flux by irradiation of the reference light flux when reproduced. In the case of a transmittance type hologram, the pitch becomes coarse and the number of interference fringes decreases if an angle between the optical axis of the reference light flux and the optical axis of the signal light flux is relatively smaller. For this reason, the reproduced light has a slightly lower diffraction efficiency and a lower angular selectivity. In contrast, the reflective type hologram forms an interference fringe layer having a fine pitch of ½ of the wavelength so that reproduced light with a higher diffraction efficiency and a higher angular selectivity can be reproduced. Therefore, actually the latter reproduced light becomes dominant so that adjacent holograms having higher angular selectivity are overlapped to be able to depress cross talk even in the cases of multiplex exposure.

A detection optical system is described subsequently also using FIG. 1. The reproduced signal light flux reflected from the recording medium 115 and the residual component of the reference light flux enter again the condenser lens 113 to be refracted, forming a linear polarization with a λ/4 plate 112 due to a 90 degree rotation of the polarization from that when first entered this λ/4 plate, to be reflected on the polarization prism reflective surface 107. Moreover, the light transmitted through the second prism reflective surface 119 is received by the two-dimensional photo detection array 120. As a two-dimensional photo detection array, video elements such as CCD elements and CMOS elements can be used. The two-dimensional photo detection array is arranged at such a position that the light on the micro variable MEMS mirror array of the spatial light modulator 109 forms an image. The pitch of the pixels on the two-dimensional photo detector array 120 must be at least the pitch of the micro variable MEMS mirror array of the spatial light modulator 109 or less. As a result, the recorded signals modulated by the spatial light modulator 109 can be decomposed. The reference light flux condensed in the center is not used for signal detection. From the light reflected on the second prism reflective surface 119, the signal light flux is removed through a pinhole 122 having an astigmatism by placing a cylindrical lens 121 and only the reference light flux is condensed by a photo detector 123. The photo detector 123 is adjusted at such a position that the reflected reference light flux forms a minimal circle of confusion when the reference light flux is condensed on the row of pits on the optical recording medium 115. By so doing, focus error signals (FES) and tracking signals are obtained from the output signals of the photo detector 123 by the servo signal operation circuit 124. The focus error signal detection uses an astigmatic method, whereas tracking signal detection uses a differential phase method. However, the servo signal detection method is not limited by these methods and other detection methods can be employed. For example, a knife edge method and a beam size detection method are available for focus error signals and a push-pull method is available for tracking signals. However, according to the knife edge method and beam size detection method, a diffraction lattice must be used instead of a cylindrical lens. According to the push-pull method, signals cannot be detected if the one-way differential phase by the pit is λ/4 so that the depth must be adjusted approximately to λ/6. The servo signals such as focus error signals and tracking signals are fed back by a servo circuit (not shown) in the controller 125. The focus error signals are fed back as drive signals in the direction of the optical axis of the lens actuator 114 and the tracking signals are fed back as drive signals in the radial direction of the recording medium via respective actuator driver circuits 130. As a result, the reference light flux can be irradiated always at the same focal position on the row of pits on the recording medium 115. Therefore, the reference light flux can be irradiated with absolutely the same configuration as that of the reference light when recorded so that signal reproduction by Bragg reflection can be carried out highly efficiently. The controller 125 also controls the two-dimensional light detector 120 via a two-dimensional light detector driver circuit 129, controls the spatial light modulator 109 via a spatial light modulator driver circuit 128, controls the variable beam splitting device 103 via a variable beam splitting device driver circuit 127, and controls the semiconductor laser 101 via a semiconductor laser driver circuit 126.

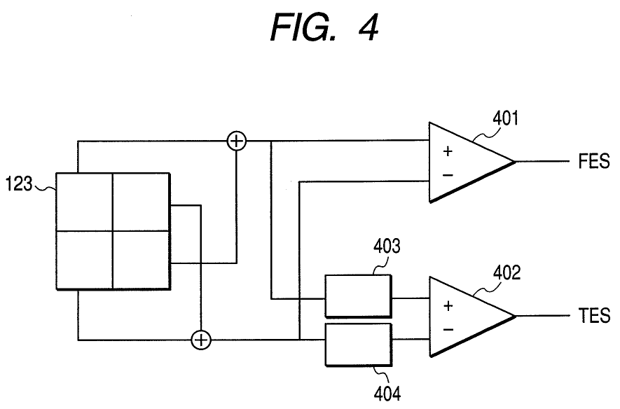

FIG. 4 is a diagram showing a configuration of a servo signal detection circuit. The photo detector 123 contains light detection areas divided into quarters and the output signals from the two respective areas that are diagonal to each other are added to generate two sets of signals. A difference between the two sets of sum signals is output via a differential amplifier 401 to obtain a focal error signal (FES). Moreover, via phase detection circuits 403 and 404 for the two sets of sum signals, phases in the direction of the time of signals from the row of pits are output as voltage signals and a tracking error signal (TES) is obtained from these differential signals. In the tracking signal detection by the differential phase method used in the DVD, a tracking signal is detected using the fact that if there is a tracking error, the photon signals by the pits cause a differential phase in the sum signals of the two areas relative to the two sets of diagonal directions in the photo detector divided into quarters. This principle is used in the present embodiment.

The present invention provides an information storage apparatus using the holographic method which can be used as video recorders and large capacity PC data backup devices.

What is claimed is:

1. An optical information storage apparatus comprising:
a laser light source;
a first beam splitting device that splits the light from the laser light source into a reference light flux and a recording light flux;
a spatial light modulator that generates recorded signal light flux by dividing said recording light flux into plural areas and modulating light intensity or phase independently according to the recorded information;
a light irradiator that irradiates said reference light flux and said recorded signal light flux on an optical recording medium;
a second beam splitting device that splits the reproduced signal light flux reproduced by irradiating the reference light flux on said recording medium from the optical path from said laser light source; and
a two-dimensional photo detector array that accepts the split said reproduced signal light flux,
wherein said first beam splitting device has functions to distribute intensities into said reference light flux and said recorded signal light flux in the entire areas of light flux, and to locally condense said reference light flux on said spatial light modulator in order to provide a phase distribution.

2. The optical information storage apparatus according to claim 1, wherein said function to provide phase distribution irradiates said recording light flux over the entire surface of the modulation area of said spatial light modulator.

3. The optical information storage apparatus according to claim 1, wherein said first beam splitting device has a function of making the intensity ratio between said reference light flux and said recorded signal light flux variable.

4. The optical information storage apparatus according to claim 1, wherein said spatial light modulator is a spatial light modulator that modulates the reflected light, has a micro mirror on its surface, and is arranged such that the reference light flux locally condensed in said spatial light modulator by the phase distribution provided by said first beam splitting device is reflected by said micro mirror.

5. The optical information storage apparatus according to claim 1, wherein the position where the reference light flux is locally condensed in said spatial light modulator is on the optical axis.

6. The optical information storage apparatus according to claim 1, further comprising:
a photo detector that receives the reflected reference light flux reflected from said optical recording medium; and
a detection unit that detects an irradiated light flux position control signal on said optical recording medium from the output signal from said photo detector.

7. The optical information storage apparatus according to claim 1, wherein said spatial light modulator further comprises a function of generating recorded signal light flux by dividing the irradiated recorded light flux into plural areas and by modulating the light intensities independently according to the recorded information as well as providing a random phase distribution to each divided area.

8. An optical recording medium for receiving a reference light flux and a recorded light flux, comprising:
a photosensitive material layer on the substrate surface and a low reflectivity pit row pattern on the back of said substrate.

9. The optical recording medium according to claim 8, wherein said substrate is a transparent substrate.
